(19) United States
(12) Patent Application Publication
(10) Pub. No.: US 2001/0042756 A1
(43) Pub. Date: Nov. 22, 2001

(54) Adjustable push forward dispensing mechanism

(76) Inventor: Alexandre Maldonado SR., Sunrise, FL (US)

Correspondence Address: ALEXANDRE MALDONADO, 12441 N 15th ST. #308, SUNRISE, FL, 33323, US

(21) Appl. No.: 09/766,720

(22) Filed: Jan. 22, 2001

(30) Foreign Application Priority Data
May 22, 2000 (BR) MU8001070-9

(51) Int. Cl. G07F 11/42

(52) U.S. Cl. 221/268

(57) ABSTRACT

A mechanism for dispensing merchandise using a support cart that slides forward on a fixed base activated by a circular cam that applies a 360° rotating motion inside a open oval shaped unit connected to a center actuator ratchet. After a grip is effected on one of the notches of the said center actuator ratchet by the latches located on the said merchandise support cart then the engagement pushes forward and drops from the base only the first object stacked to the furthermost position of the base. Comprising of a fixed base, two fixed ratchets, a sliding merchandise support cart with three latches, one center actuator ratchet connected to a open oval shaped unit, a circular cam with various holes positions to mount an axis where said each hole position determines the distance for the said support cart to move.

### BACKGROUND DESCRIPTION

The present invention relates to an adjustable dispensing mechanism with a multi-position cam that effects a reciprocate movement to a actuator ratchet enabling a merchandise support cart to slide along a base surface that accommodates products of different shapes and sizes displaying to consumers with the purpose of engaging into an automatic vend.

Many different mechanism systems are utilized to dispense and vend merchandise in automatic devices known as vending machines. For certain products especially packages with geometrical formats such as rectangular and square boxes, the conventional mechanism systems seems to function in an adaptive basis meaning they were not specifically made to optimize issues like best exhibition and maximum capacity storage.

Hence it is the object of this invention to provide a novel mechanism dispensing system that features more products vend capacity for a number of different merchandise accommodation with best exposure to the costumers and total flexibility allowing to be installed in many different types of machine.

This object is achieved in that the merchandises are loaded closely behind each other clear from any object dividers interference maximizing space and displayed perfectly straight towards the glass front of the machine for best exhibition to the customers. The circular cam rotating inside a open oval shaped unit comprises a number of different strokes to the actuator ratchet connected allowing to be dispensed various types of merchandise by a simple adjustment on the position of the axis in the said circular cam.

Other advantages such as easy loading of merchandise are effective features related to increment cost effectiveness and operability. The merchandise support cart is retractable by a simple one-handed maneuver.

Utilizing plastic material on molding injection process, the mechanism is manufacture at very low cost.

### BRIEF SUMMARY OF THE INVENTION

In summary, the primary object of the instant invention is to maximize vend capacity and better exhibit merchandise on vending machines and others automatic display devices. The present invention presents a novel cam system functioning on a very reduced physical area allowing more space for merchandise vend and exposure.

The present invention has the flexibility to be installed on most conventional snack type vending machines and to accommodate many different types of products considering various shapes and sizes by a simple adjustment setting on the cam.

The products to be vended are loaded on a base that has a sliding support cart that holds all merchandises on the same angle facing the front of the machine. A circular cam located on the rear of the mechanism effects a 360° motion inside an open oval shaped unit connected to an center actuator ratchet making the said center actuator ratchet move back and forth according to the position the axis was mounted to the said circular cam that corresponds to the thickness of the product to be dispensed.

The said support cart comprising three latches slides forward once a grip is effective by the center latch on the notch of the said center actuator ratchet dropping the first product loaded to the furthermost position on the said base. When the said actuator ratchet returns to its home position finalizing the cam's rotating movement the said support cart stays putt to the last position due to the release of the said center latch and the effective grip of the latches located on the side of the said support cart to the notch of the fixed ratchets mounted to the base.

The nature, utility and principle of the present invention will be more clearly understood from the following detailed description thereof when read with reference to the accompanying drawings.

### BRIEF DESCRIPTION OF THE SEVERAL VIEWS OF THE DRAWINGS

The following drawings illustrates from a perspective view the present invention:

FIG. 1—shows a perspective view of the total assembly of the dispensing mechanism where (1) is the fixed base, (2) sliding support cart, (3) the latch on the side, (4) center latch, (5) side ratchets mounted to the base, (6) center ratchet, (7) open oval shape unit connected to the center ratchet, (8) circular cam, (9) hole to mount the axis.

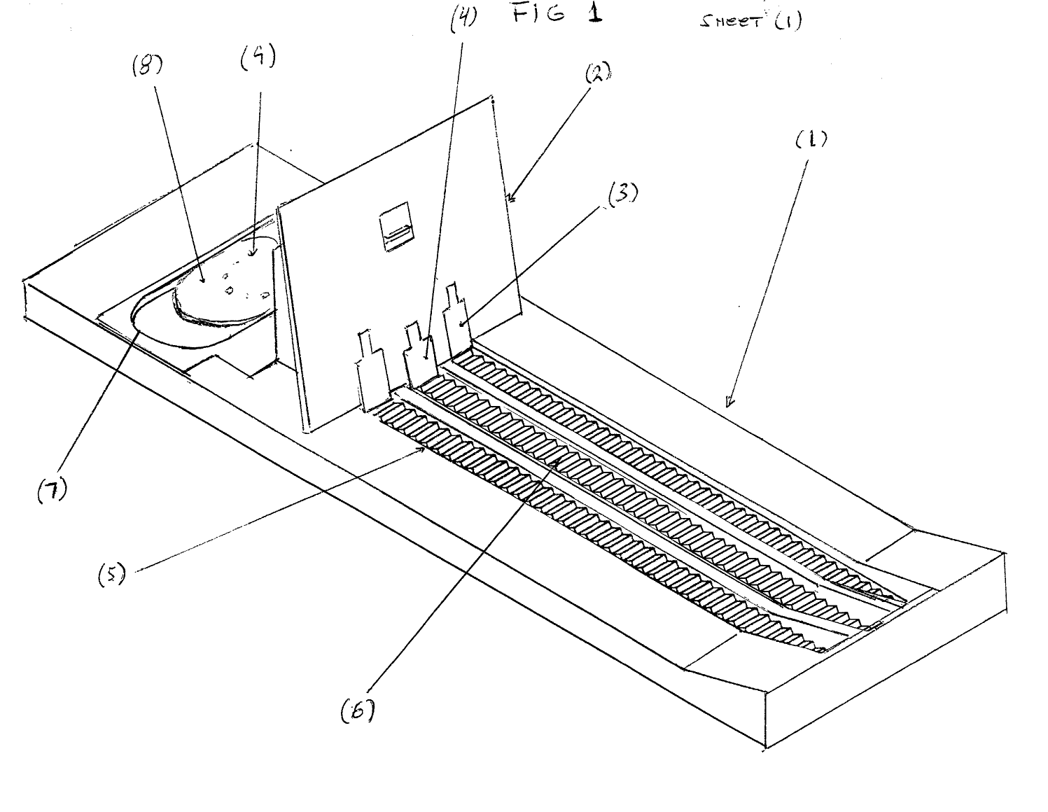

FIG. 2—shows a flat view of the entire mechanism and its components.

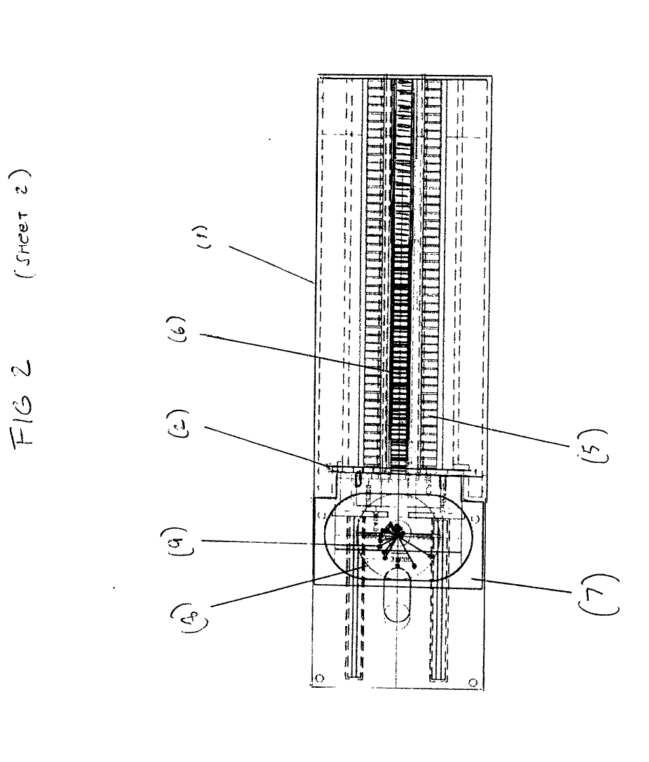

### DETAILED DESCRIPTION OF THE INVENTION

The present invention title as Adjustable Push Forward Dispensing Mechanism comprises of one fixed base (1) with two ratchets mounted on the side (5), one center actuator ratchet (6) connected to an open oval shaped unit (7), a circular cam (8) with various hole (9) positions to mount an axis, and a sliding support cart (2) with three independent latches, one center latch (4) and two latches on the side (3).

With the object of displaying and dispensing consumer products the present invention functions on a very simple manner by loading a merchandise on top of the said fixed base supported by the said support cart that accommodates the products on a 12° angle inclination facing the front of the said base to be exposed to the costumer.

In order to be dispensed one product at a time the said actuator ratchet with various notches works in combination with the said sliding support cart in such a way that the said center latch located on the said support cart moves vertically by gravity climbing and gripping each notch of the said center actuator ratchet as the said support cart slides forward. The same movement is effective on the latches located on the side of the said support cart on top of the said ratchets mounted to the said fixed base and independently from the said center latch. When the center actuator ratchet is activated by a circular cam mounted to an axis connected to a motor that applies a 360° rotating motion to the said cam inside an open oval shaped unit that has on the narrower gap the same measurement as the diameter of the said circular cam the said center actuator ratchet travels on a reciprocate path. The said center latch grips to the notch of the said center actuator ratchet pushing the said support cart forward only to the distance set by the said circular cam mechanism described thereafter. The said circular cam has various hole positions placed off from the center purposely to set different strokes to the said actuator ratchet. When the axis is placed on the nearest hole position from the center of the said circular cam the said center actuator ratchet moves a shorter stroke and vice versa. The stroke is determined by the distance of the hole positioned from the center of the said circular cam. For example if the desire stroke is 1″ inch long then the axis has to be positioned on the hole that is ½″ inch away from the center point of the said circular cam and so forth. The maximum stroke would be two times the ratio of the said circular cam or he total diameter of the said circular cam. Therefore to dispense merchandise is necessary to measure the thickness of each product in order to adjust the position of the axis on the said circular cam hole. When the said circular cam finalizes its 360° rotating motion returning the said center actuator ratchet to the home position, the said support cart stays putt due to the release of the said center latch and the grip of the said latches located on the side of the said support cart. When the said support cart is pushed forward by the previous described mechanism the first product loaded to the furthermost position is dropped of from the base.

What I claim is: An adjustable dispensing mechanism for merchandising and dispensing multi products through the method previously described and the apparatus thus utilized for the purpose as follow:

1. A circular cam that applies a 360° rotary motion inside an open oval shaped unit connected to an actuator ratchet effecting a reciprocate movement of the said actuator ratchet. The cam with various holes to position the axis starting off from the center of the said circular cam, said each hole determines the stroke the said actuator ratchet would move back and forth along the base.

2. An adjustable dispensing mechanism comprising of two fixed ratchets mounted to a fixed base along with a support cart that travels a distance determined by the position of the axis mounted to a circular cam that applies a 360° rotating motion inside a open oval shaped unit connected to a center actuator ratchet. Once a grip is effected by the center latch located on the said merchandise support cart to the actuator center ratchet notch, the said support cart slides forward to the set distance determined by the position of the axis on the said circular cam that corresponds to the thickness of the product to be dispensed, and when the said circular cam returns to the home position finalizing its 360° rotating motion the said merchandise support cart stays on the last position due to the release of the said center latch and the effective grip of the two side latches also located on the said merchandise support cart to the said fixed ratchets notches mounted to the said fixed base.
